(19) United States
(12) Patent Application Publication
(10) Pub. No.: US 2021/0201279 A1
(43) Pub. Date: Jul. 1, 2021

(54) LEGAL NAME UPDATING ACROSS ACCOUNTS

(71) Applicant: Capital One Services, LLC, McLean, VA (US)

(72) Inventors: Lara MOSSLER, Farmville, VA (US); Christina EGEA, Washington, DC (US); Karl AZZAM, McLean, VA (US); Francis ACU, Midlothian, VA (US)

(73) Assignee: Capital One Services, LLC, McLean, VA (US)

(21) Appl. No.: 16/731,584

(22) Filed: Dec. 31, 2019

(51) Int. Cl. G06Q 20/10; H04L 29/08; H04L 29/06; G06Q 20/40; G06Q 40/02

(52) U.S. Cl. CPC G06Q 20/108; G06Q 20/102; G06Q 40/02; H04L 63/0815; G06Q 20/4014; H04L 67/306

(57) ABSTRACT

Various embodiments are directed to updating user accounts with a correct legal name. For example, it may be determined whether two or more user accounts associated a single sign-on identifier (SSOID) exist. If the accounts exist, the customer names associated with the accounts may be identified. Based on the parsing of the names, it may be determined whether there is a name mismatch and/or a typographical error in any of the identified names. Based on the determination, the names may be presented to the user such that the user can select a correct name. User accounts with incorrect names may be updated with the correct name provided by the user.

### BACKGROUND

A customer may have multiple online accounts with a merchant. For example, a banking customer may have different types of online accounts with a financial institution under one set of login credentials, such as a checking account, a savings account, multiple credit card accounts, and money market accounts.

Because different accounts may be opened at different times, legal names associated with the accounts may change or vary over time. For example, a customer may open an account under a maiden name prior to marriage. But after getting married, the customer may open a different account under a new, married name. Thus, the customer may have multiple accounts that have different legal names under the same set of login credentials.

Typically, to change a legal name associated with an account, the customer may be required to contact a call center for each account the customer wishes to modify. This is not only time consuming and inefficient for the customer, but also incredibly costly for the merchant.

### SUMMARY

Various embodiments are directed to updating user accounts with a correct legal name. For example, it may be determined whether two or more user accounts associated a single sign-on identifier (SSOID) exist. If the accounts exist, the customer names associated with the accounts may be identified. Based on the parsing of the names, it may be determined whether there is a name mismatch and/or a typographical error in any of the identified names. Based on the determination, the names may be presented to the user such that the user can select a correct name. User accounts with incorrect names may be updated with the correct name provided by the user.

### BRIEF DESCRIPTION OF THE DRAWINGS

FIG. 1 illustrates an example name update engine in accordance with one or more embodiments.

FIG. 2 illustrates an example set of user accounts associated with a single sign-on identifier (SSOID) in accordance with one or more embodiments.

FIG. 3 illustrates an example of enhanced parsing in accordance with one or more embodiments.

FIG. 4 illustrate example name mismatches, typographical errors, and misspellings in accordance with one or more embodiments.

FIG. 5 illustrates an example user interface flow in accordance with one or more embodiments.

FIG. 6 illustrates an example flow diagram in accordance with one or more embodiments.

FIG. 7 illustrates an example computing architecture of a computing device in accordance with one or more embodiments.

FIG. 8 illustrates an example communications architecture in accordance with one or more embodiments.

### DETAILED DESCRIPTION

Various embodiments are generally directed to updating one or more user accounts with a correct legal name in an efficient and cost-effective manner. According to embodiments, a single sign-on identifier (SSOID), such as a username or other types of login credentials, corresponding to a user may be used to determine whether there are two or more user accounts associated with the SSOID, e.g., checking account, a savings account, a credit card account, etc. Parsing may then be performed on all of the customer names associated with the accounts to determine whether a name update is required. For instance, based on the parsing, if it is determined that there are any name mismatches and/or typographical errors, all of the customer names (excluding duplicates) may be presented to the user, who may then select the correct legal name for updating. All applicable accounts may then be updated with the correct legal name of the user.

In examples, system-side enhanced parsing techniques may be used to determine whether a name update is necessary before involving the user. For instance, if the enhanced parsing reveals a difference between at least two customer names that is a suffix addition, an extra space addition, or an extra non-alphanumeric character addition, the name update may not be recommended. If, however, the enhanced parsing reveals a partial or complete name mismatch between at least two customer names or any typographical errors therebetween, the name update may be recommended.

As described above, updating names on user accounts was an extremely inefficient, time-consuming, and cumbersome process. The embodiments, examples, and aspects of the present disclosure overcome and are advantageous over the previous solutions in that at least a determination of whether to recommend a name update may first be performed at the system-side before involving the user, and based on the determination, the user may be presented with an efficient, streamlined way of updating all user accounts with the correct legal name.

Reference is now made to the drawings, where like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form to facilitate a description thereof. The intention is to cover all modification, equivalents, and alternatives within the scope of the claims.

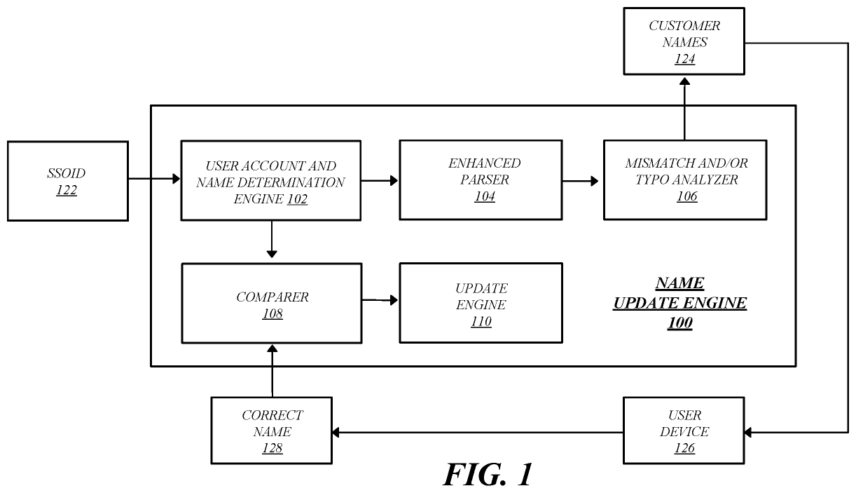

FIG. 1 illustrates an example name update engine 100 according to embodiments. As shown, the name update engine 100 may include at least a user account and name determination engine 102, an enhanced parser 104, a name mismatch and/or typographical error analyzer 106, a comparer 108, and an update engine 110. It may be understood that the name update engine 100 and the components therein may be executed, run, and/or supported by one or more computing devices. It may also be understood that the functionalities of two separate components in the name update engine 100 may be combined or performed by one component, for example, the enhanced parser 104 may perform the mismatch and/or typo analysis that that the name mismatch and/or typographical error analyzer 106 may perform.

In examples, the user account and name determination engine 102 may be configured to receive a single sign-on identifier (SSOID) associated with a user. The SSOID may be any information, e.g., a username, a password, or other types of login credentials, that allows the user to gain access to one or more user accounts via a single login session. Based on the received SSOID, the user account and name determination engine 102 may identify all active accounts associated with the SSOID and determine whether two or more accounts exist. If two or more exist, the user account and name determination engine 102 may retrieve all the customer names associated with those accounts.

As further shown, the customer names may be forwarded to or received by the enhanced parser 104. As described above, the enhanced parser 104 may be the component in the name update system that determines whether a name update should even be recommended. In examples, the enhanced parser 104 may parse the customer names and analyze the names for differences. For instance, one customer name may include a suffix and a different customer name may not include the suffix. In another instance, one customer name may include an extra space and/or an extra non-alphanumeric character and a different customer name may not. In either of these instances, the enhanced parser 104 may determine that the differences do not amount to different names and may not recommend a legal name update. All other differences may be processed by the name mismatch and/or typographical error analyzer 106, which may be its own component as shown in FIG. 1, or in other examples, may be part of the enhanced parser 104 as stated above.

The analyzer 106 may determine whether there are any mismatches (e.g., complete mismatches, partial mismatches) and/or typographical errors in the customer names. In examples, a partial or complete name mismatch may include a complete last name mismatch, a complete first name mismatch, a partial last name mismatch, a partial first name mismatch, and/or a transposition of a first name and a last name. In further examples, typographical errors may include a misspelling of a known correct last name of the user, a misspelling of a known correct first name, at least one letter different than the known correct last name, and/or at least one letter different from the known correct first name. It may be understood that the partial or complete name mismatch does not include suffix additions and also that the typographical error does not include extra space or non-alphanumeric character additions.

When the analyzer 106 determines that partial or complete name mismatch(es) and/or typographical error(s) exist, the name update engine 100 may present all of the customer names 124 (excluding duplicates) identified by the user account and name determination engine 102 to the user. For examples, the names may be displayed on a user device 126 via a banking app being executed thereon. As will be further described below, the user may select the correct legal name from the presented names. The correct legal name may be used by the comparer 108 to determine which of the customer names and the associated accounts require updating. Thereafter, the update engine 110 may update all applicable accounts with the correct legal name provided by the user.

Advantageously, the name update engine 100 predetermines for the user whether name updates are required prior to involving the user. And when the user is involved, updating the accounts is an efficient and easy process by way of at least the one-time selection of the correct legal name.

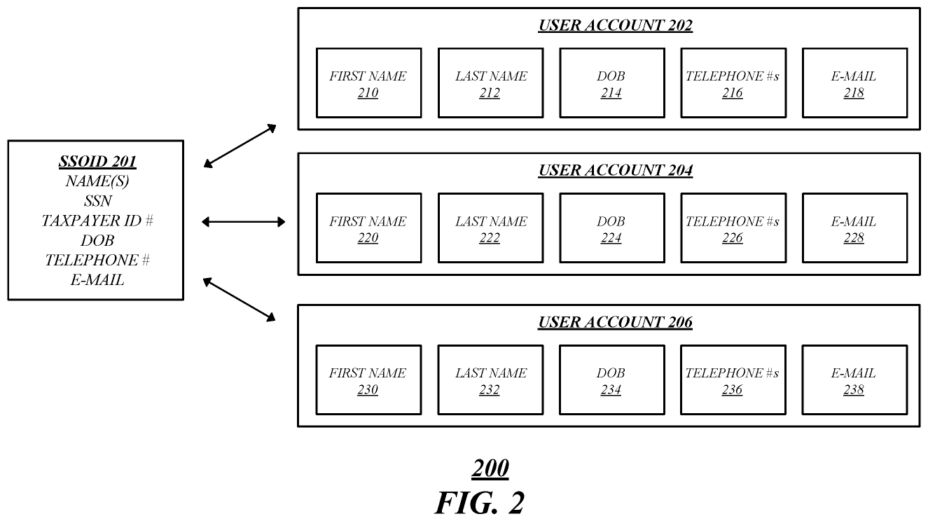

FIG. 2 illustrates an example set 200 of user accounts associated with an SSOID 201 according to embodiments. As shown, at least user accounts 202, 204, and 206 may be associated with SSIOD 201. Each of the user accounts may include, define, or indicate information, e.g., personally identifiable information (PII), pertaining to the user. For example, user account 202 may define at least a first name 210 of the user, a last name 212, a date of birth (DOB) 214, a telephone number 216, and an e-mail address 218. Similar types of information may also be defined by user accounts 204 and 206, e.g., first names 220 and 230, last names 222 and 232, DOBs 224 and 234, telephone numbers 226 and 236, and e-mail addresses 228 and 238. As described above, it may be understood that the SSOID 201 may be a username or any other suitable login credential that the user may use to gain access to the accounts 202, 204, and 206.

As further shown, the SSOID 201 may also include, define, or indication user such as one or more associated names, social security number (SSN), taxpayer ID number, date of birth, telephone number(s), e-mail address, etc. In examples, one or more of the PII defined by the SSOID 201 may be used (by the user account and name determination engine 102 of the name update engine 100 in FIG. 1, for example) to determine or locate user accounts associated with the SSOID 201. For instance, a match between the DOBs and the e-mail address of the SSOID 201 and user account 202 may indicate that user account 202 is associated with SSOID 201. In some examples, user PII that rarely or never changes, such as social security number, taxpayer ID number, DOB, driver license or ID number, e-mail address, etc., may always be used to perform the matching.

Because there are two or more user accounts that have been identified as being associated with the SSOID 201 in the set 200, enhanced parsing may be performed on the customer names (e.g., first names 210, 220, 230, last names 212, 222, 232) to determine whether remediation (e.g., name updating) on any of the accounts is required.

It may be understood that the determination, location, or identification of the user accounts associated with the SSOID may be based on deterministic matching (and not probabilistic matching). For example, deterministic matching may involve searching through user data sets to link all user profiles that belong to the same user via a common identifier, such as a first name, last name, address, e-mail address, DOB, telephone numbers, etc., whereas probabilistic matching is based on algorithms to identify the same user across different devices and applications.

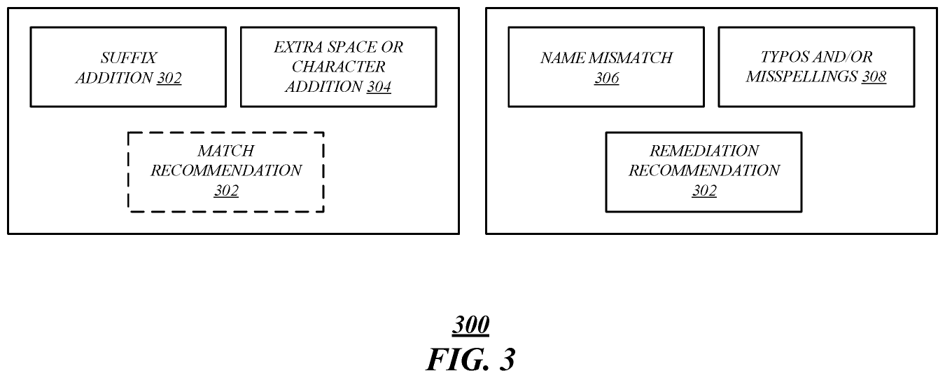

FIG. 3 illustrates an example of enhanced parsing 300 according to embodiments. For ease of explanation, the customer names 202, 204, 206 illustrated in FIG. 2 will be used to describe the enhanced parsing process. For example, enhanced parsing 300 may be performed to parse out and perform analysis on the alphanumeric and/or non-alphanumeric characters contained in the customer names associated with the accounts 202, 204, 206.

The enhanced parsing 300 may reveal differences (or similarities) among the names. In one example, a customer name may have a suffix addition 302 (e.g., any suffix added to the name) compared to the other names. In another example, a customer name may include an extra space or non-alphanumeric character addition 304 compared to the other names. In a further example, there may be a partial or a complete customer name mismatch 306 between at least two names. In yet another example, it may be determined that there are typo(s) and/or misspelling(s) 308 in one or more of the customer names.

As shown, instances of suffix additions and extra space or non-alphanumeric character additions among the customer names may not be enough to recommend remediation (e.g., legal name update) since the names are not technically incorrect, and thus, a match recommendation 302 may be generated based on the enhanced parsing 300. As further shown, instances of partial or complete name mismatches and typos and/or misspellings among the names, however, may trigger a remediation recommendation.

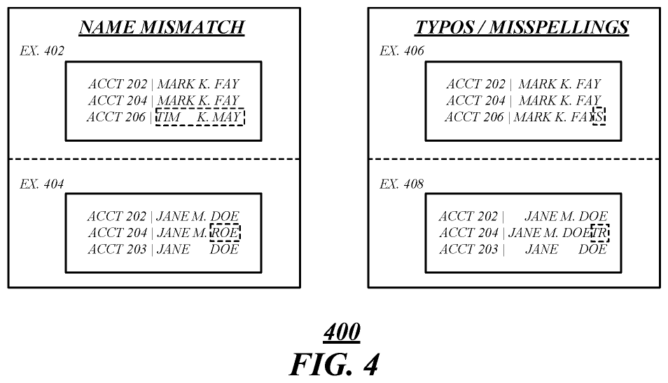

FIG. 4 illustrates example name mismatches, typographical errors, and misspellings 400 according to embodiments. Two name mismatch examples 402 and 404 are shown. For instance, in example 402, accounts 202 and 204 may include or indicate the same name, “Mark K. Fay,” but account 206 may include or indicate a completely different name, “Tim K. May.” This may be considered a complete name mismatch (e.g., where both the first and last names are different, where the first names are different, where the last names are different). In example 404, accounts 202 and 206 may include or indicate the same first and last names, “Jane M. Doe” and “Jane Doe,” but account 204 may include or indicate a different last name, “Jane M. Roe.” This may be also considered a complete name mismatch since the last names are different, but in some examples, partial name mismatches are possible, e.g., where one last name is “Doe” and a second last name is “Doe-Moe” (hyphenated or otherwise combined last names). Partial or complete name mismatches may occur for various reasons, such as name changes after marriage, voluntary name changes or the like.

Moreover, two typo or misspelling examples 406 and 408 are shown in FIG. 4. In example 406, accounts 202 and 204 may include or indicate the same name, “Mark K. Fay,” but account 206 may indicate “Mark K. Fays,” where an extra letter, “s,” is placed after “Fay” by way of a typographical error. In example 408, accounts 202 and 206 may share the same first and last names “Jane M. Doe” and “Jane Doe,” but account 204 may include or indicate a misspelled last name, “Doetr.” Typographical errors or misspellings may occur if the user accidentally misspells or “fat fingers” the user's name.

As described above, a partial or complete name mismatch may include a complete last name mismatch, a complete first name mismatch, a partial last name mismatch, a partial first name mismatch, and/or a transposition of a first name and a last name. Typographical errors may include a misspelling of a known correct last name of the user, a misspelling of a known correct first name, at least one letter different than the known correct last name, and/or at least one letter different from the known correct first name.

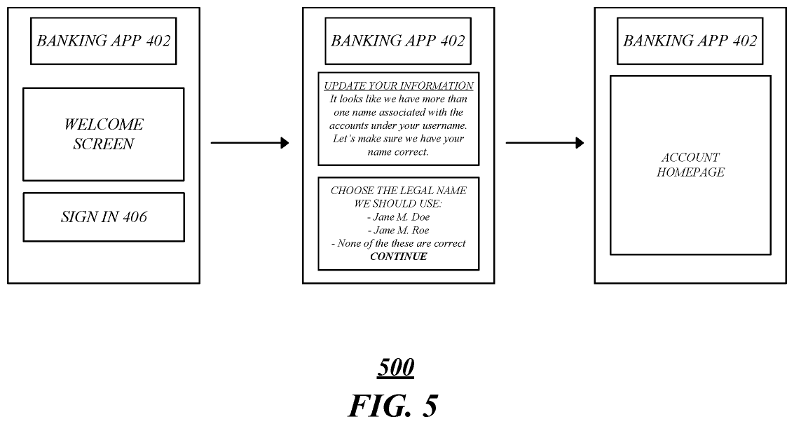

FIG. 5 illustrates an example user interface flow 500 for selecting a correct legal name according to embodiments. As shown, a user may open a banking app 402, which may display a welcome screen and prompt the user to sign in to the banking app 402 via the sign-in icon 406. As described above, the user's login credentials (e.g., username) may be considered the SSOID that is used to determine if more than one account is associated with the user via the SSOID.

In examples, if it is determined that there are multiple accounts associated with the SSOID and that there are partial or complete name mismatches and/or typographical errors among the customer names, the names (excluding duplicates) are presented to the user on a fix-up screen. As illustrated, the fix-up screen may indicate to the user that there are multiple names associated with accounts under the username. The user may then select the correct legal name from the presented names on the fix-up screen. If none of the displayed names are correct, the user may select the “none of these names are correct” option or the like, which then directs the user to contact a call center for further assistance. Thereafter, the user is transitioned from the fix-up screen to an account homepage, where the name update is applied to all the accounts associated with the SSOID. It may be understood that the name update is propagated on the system backend, for example, by a name update engine (e.g., name update engine 100 of FIG. 1).

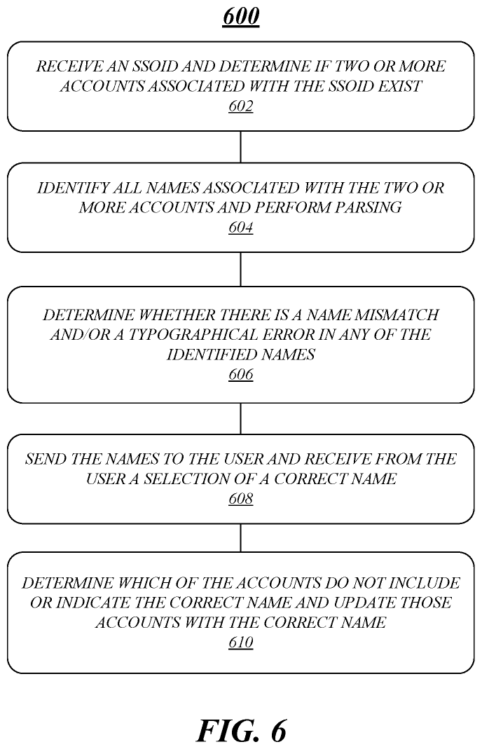

FIG. 6 illustrates an example flow diagram 600 according to one or more embodiments. It may be understood that the features associated with the illustrated blocks may be performed or executed by one or more computing devices and/or processing circuitry contained therein that can run, support, execute a digital marketing rules engine, such as the one illustrated in FIG. 1.

At block 602, a single sign-on identifier (SSOID) may be received from a user. In examples, the SSOID may be a username associated with accessing the user's accounts or may be any other identifier that uniquely associates the user to the user's accounts. Further at block 602, it may be determined whether two or more user accounts associated with the SSOID exist. As described above, the determination may be based on deterministic matching as opposed to probabilistic matching, e.g., user data points such as a user e-mail address may be used to locate accounts also associated with that e-mail address.

At block 604, all of the customer names associated with the user accounts may be identified so that enhanced parsing can be performed thereon. As described above, parsing the names may reveal a suffix addition in at least one name over the other names, an extra space or non-alphanumeric character addition in at least one name over the other names, a partial or complete name mismatch among at least two names, and/or typographical errors. Remediation, e.g., a name update, may be recommended for the partial or complete name mismatch and the typographical errors, but not for the suffix addition and the extra space or non-alphanumeric character addition.

At block 606, it is determined whether a name mismatch (partial or complete) and/or a typographical error exists in any of the identified customer names. As described above, a complete name mismatch may be when at least two names (first and/or last) are entirely different. A partial name mismatch may be when at least one name contains at least portion of a different name but not identical to each other (e.g., a last name and that last name hyphenated or added with a different last name). Moreover, the typographical error may include a misspelling of a name or being at least one letter different or off from a known correct name.

At block 608, if it is determined that a partial or complete name mismatch and/or typographical error exists in the identified customer names, the set of names (excluding duplicates) may be send to the user so that the user can select a correct legal name for updating the incorrect user accounts. For example, the names may be presented to the user via a banking app interface. In some examples, the user may be directed by the banking app interface to contact a call center if none of the presented names include a correct name.

At block 610, it is determined which of the user accounts do not include or indicate the correct legal name selected by the user at block 608, which are then updated with the correct name. In at least this regard, at least the features described in flow 600 advantageously allow user accounts to be updated with the user's correct legal name in an efficient, streamlined, and cost-effective manner, which promotes and ensures at least overall account-related security for the user.

Moreover, it may be understood that the blocks illustrated in FIG. 6 are not limited to any specific order and/or one or more of the blocks may be performed or executed simultaneously or near simultaneously.

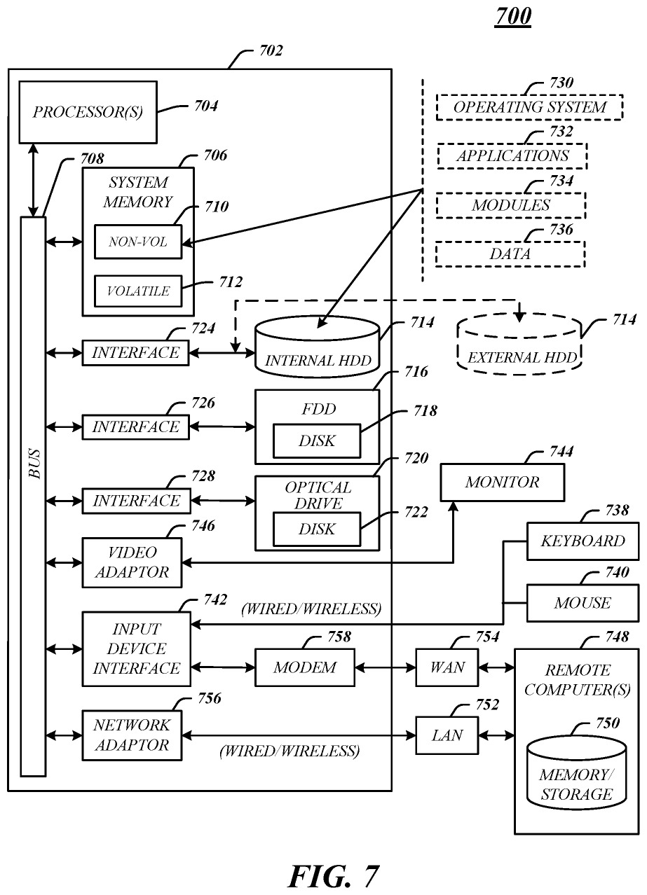

FIG. 7 illustrates an embodiment of an exemplary computing architecture 700, e.g., of a computing device, such as a desktop computer, laptop, tablet computer, mobile computer, smartphone, etc., suitable for implementing various embodiments as previously described. In one embodiment, the computing architecture 700 may include or be implemented as part of a system, which will be further described below. In examples, one or more computing devices and the processing circuitries thereof may be configured to at least run, execute, support, or provide a legal name update engine, e.g., the name update engine 100 and related functionalities.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 includes processor 704, a system memory 706 and a system bus 708. The processor 704 can be any of various commercially available processors, processing circuitry, central processing unit (CPU), a dedicated processor, a field-programmable gate array (FPGA), etc.

The system bus 708 provides an interface for system components including, but not limited to, the system memory 706 to the processor 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 800.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 704 through an input device interface 742 that is coupled to the system bus 708 but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754 or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.118 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

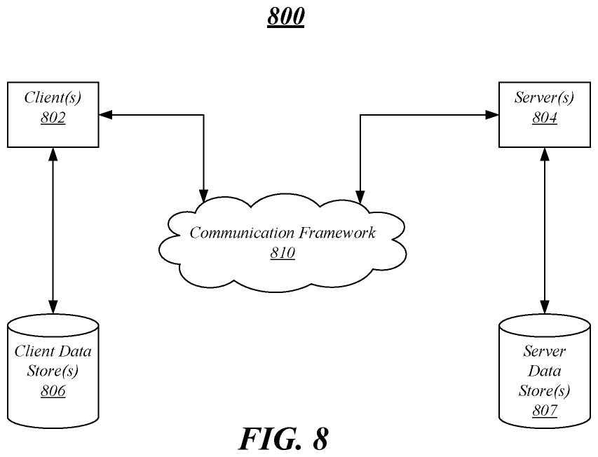

FIG. 8 is a block diagram depicting an exemplary communications architecture 800 suitable for implementing various embodiments. For example, one or more computing devices may communicate with each other via a communications framework, such as a network. At least a first computing device connected to the network may be one or more server computers, which may be implemented as a back-end server or a cloud-computing server, which may run the legal name update engine described herein, e.g., name update engine 100, and perform all related functionalities. At least a second computing device connected to the network may be a user computing device, such as a mobile device (e.g., laptop, smartphone, tablet computer, etc.) or any other suitable computing device that belongs to the user, configured to run or execute the above-described banking app and support functionalities related to prompting and receiving a correct name selection from the user. In further examples, at least the second computing device may be a computing device belonging to a customer.

The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The one or more clients 802 and the servers 804 are operatively connected to one or more respective client data stores 806 and server data stores 807 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose and may be selectively activated or reconfigured by a computer program stored in the computer. The procedures presented herein are not inherently related to a particular computer or other apparatus. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system comprising:
one or more computing devices, wherein the one or more computing devices comprises:
a memory to store instructions; and
processing circuitry, coupled with the memory, operable to execute the instructions, that when executed, cause the processing circuitry to:
receive a single sign-on identifier (SSOID) from a user;
determine, via deterministic matching, whether there are two or more user accounts associated with the SSOID, and based on the determination, identify at least a first customer name and a second customer name associated with the two or more user accounts, wherein the deterministic matching comprises searching through user data sets and linking all user accounts in the user data sets that correspond to the user via a common identifier associated with the SSOID;
perform parsing on at least the identified first and second customer names;
determine, based at least in part on the parsing, whether there is a partial or complete name mismatch between at least the first and second customer names, wherein the determination of the partial or complete name mismatch comprises determining whether a difference between the first and second customer names is a suffix addition, an extra space, or an extra non-alphanumeric character addition, and in response the suffix addition, the extra pace, or the extra non-alphanumeric character addition being the only difference, determine that there is no partial or complete name mismatch;
provide at least the first and second customer names to an application interface for the user to select a correct name based on the determination that at least the first and second customer names partially or completely mismatch;
receive an interface selection from the user via the application interface of the correct name from at least the provided first and second customer names, the correct name being a currently-used proper legal name corresponding to the user;
determine which of the two or more user accounts are not associated with the selected correct name; and
update any of the two or more user accounts unassociated with the correct name to the correct name in the user data sets.

2. The system of claim 1, wherein the partial or complete name mismatch includes (i) a complete last name mismatch, (ii) a complete first name mismatch, (iii) a partial last name mismatch, (vi) a partial first name mismatch, and/or (v) a transposition of a first name and a last name.

3. The system of claim 1, wherein the partial or complete name mismatch includes a typographical error, wherein the typographical error includes (i) a misspelling of a known correct last name, (ii) a misspelling of a known correct first name of the user, (iii) being at least one letter different from the known correct last name, and/or (iv) being at least one letter different from the known correct first name.

4-5. (canceled)

6. The system of claim 1, wherein the processing circuitry is further caused to:
provide an option to the user, along with the presented customer names, that none of the presented customer names is the correct name; and
direct, based on the user selecting the option, the user to call or dial a customer service phone number.

7. The system of claim 1, wherein the processing circuitry is further caused to:
present to user, via the application interface, an account homepage displaying the updated two or more accounts; and
receive, from the user, confirmation that the updated accounts are correct.

8. The system of claim 1, wherein the determination of whether there are two or more user accounts associated with the SSOID is not based on probabilistic matching.

9. A method comprising:
receiving a single sign-on identifier (SSOID) from a user;
determining, via one or more processors, whether there are two or more user accounts associated with the SSOID based on deterministic matching, and based on the determining, identifying at least a first customer name and a second customer name associated with the two or more user accounts, wherein the deterministic matching comprises searching through user data sets and linking all user accounts in the user data sets that correspond to the user via a common identifier associated with the SSOID;
performing, via the one or more processors, parsing on at least the identified first and second customer names;
determining, via the one or more processors, whether there is a partial or complete name mismatch between at least the first and second customer names based at least in part on the parsing, wherein the determining of the partial or complete name mismatch comprises determining whether a difference between the first and second customer names is a suffix addition, an extra space, or an extra non-alphanumeric character addition, and in response the suffix addition, the extra pace, or the extra non-alphanumeric character addition being the only difference, determining that there is no partial or complete name mismatch;
providing, via the one or more processors, at least the first and second customer names to an application interface for selecting a correct name based on the determination that at least the first and second customer names partially or completely mismatch;
receiving an interface selection from the user via the application interface of the correct name from at least the provided first and second customer names, the correct name being a currently-used proper legal name corresponding to the user;
determining, via the one or more processors, which of the two or more user accounts are not associated with the selected correct name; and
updating, via the one or more processors, any of the two or more user accounts unassociated with the correct name to the correct name in the user data sets.

10. The method of claim 9, wherein the determining of whether there are two or more user accounts associated with the SSOID is not based on probabilistic matching.

11. The method of claim 9, further comprising:
determining one or more personally identifiable information (PII) associated with the SSOID; and
performing a search for all user accounts associated with the PII, and
wherein the PII includes a social security number, taxpayer identification number, date of birth, a phone number, and/or an address associated with the user.

12. The method of claim 9, wherein the partial or complete name mismatch includes (i) a complete last name mismatch, (ii) a complete first name mismatch, (iii) a partial last name mismatch, (vi) a partial first name mismatch, and/or (v) a transposition of a first name and a last name.

13. The method of claim 9, wherein the partial or complete name mismatch includes a typographical error, wherein the typographical error includes (i) a misspelling of a known correct last name, (ii) a misspelling of a known correct first name of the user, (iii) being at least one letter different from the known correct last name, and/or (iv) being at least one letter different from the known correct first name.

14-15. (canceled)

16. A non-transitory computer-readable storage medium storing computer-readable program code executable by a processor to:
receive a single sign-on identifier (SSOID) from a user;
determine, via deterministic matching, whether there are two or more user accounts associated with the SSOID, and based on the determination, identify at least a first customer name and a second customer name associated with the two or more user accounts, wherein the deterministic matching comprises searching through user data sets and linking all user accounts in the user data sets that correspond to the user via a common identifier associated with the SSOID;
perform parsing on at least the identified first and second customer names;
determine, based at least in part on the parsing, whether there is a partial or complete name mismatch between at least the first and second customer names, wherein the determination of the partial or complete name mismatch comprises determining whether a difference between the first and second customer names is a suffix addition, an extra space, or an extra non-alphanumeric character addition, and in response the suffix addition, the extra pace, or the extra non-alphanumeric character addition being the only difference, determine that there is no partial or complete name mismatch;
provide at least the first and second customer names to an application interface for the user to select a correct name based on the determination that at least the first and second customer names partially or completely mismatch;
receive an interface selection from the user via the application interface of the correct name from at least the provided first and second customer names, the correct name being a currently-used proper legal name corresponding to the user;
determine which of the two or more user accounts are not associated with the selected correct name; and
update any of the two or more user accounts unassociated with the correct name to the correct name in the user data sets.

17. The non-transitory computer-readable storage medium of claim 16, wherein the correct name is a currently-used proper legal name corresponding to the user.

18. The non-transitory computer-readable storage medium of claim 16, wherein the determination of whether there are two or more user accounts associated with the SSOID is not based on probabilistic matching.

19. The non-transitory computer-readable storage medium of claim 16, wherein the partial or complete name mismatch includes (i) a complete last name mismatch, (ii) a complete first name mismatch, (iii) a partial last name mismatch, (vi) a partial first name mismatch, and/or (v) a transposition of a first name and a last name.

20. The non-transitory computer-readable storage medium of claim 16, wherein the partial or complete name mismatch includes a typographical error, wherein the typographical error includes (i) a misspelling of a known correct last name, (ii) a misspelling of a known correct first name of the user, (iii) being at least one letter different from the known correct last name, and/or (iv) being at least one letter different from the known correct first name.
